(19) United States
(12) Patent Application Publication
(10) Pub. No.: US 2021/0209924 A1
(43) Pub. Date: Jul. 8, 2021

(54) OVERHEAD DOOR MONITOR AND SENSOR APPARATUS

(71) Applicant: Synergy Product Solutions Inc., Warren, OH (US)

(72) Inventors: James B. Brown, Crystal Lake, IL (US); Brian W. Fanelli, Estero, FL (US)

(21) Appl. No.: 17/142,888

(22) Filed: Jan. 6, 2021

Related U.S. Application Data
(60) Provisional application No. 62/957,504, filed on Jan. 6, 2020.

(51) Int. Cl. G08B 21/18; E06B 3/70; B60J 5/10; B60J 5/12; G01P 15/18

(52) U.S. Cl. CPC G08B 21/18; E06B 3/70; B60J 5/108; B60J 5/125; G01P 15/18; H04B 1/02; E05Y 2400/44; E05Y 2600/46; E05Y 2900/106; E05Y 2900/516; E05Y 2400/66; E06B 2003/7044

(57) ABSTRACT

An overhead door monitor and sensor apparatus comprises a housing having one or more sensor elements therein attached to an overhead door. The sensor elements collect data from the overhead door, such as whether the door is open or closed, the number of times the overhead door is opened, and operational conditions of the door. Moreover, the information may be stored and may further be wirelessly transferable to a computing device, such as a smart device.

### CROSS-REFERENCE TO RELATED APPLICATIONS

The present invention claims priority to U.S. Prov. Pat. App. No. 62/957,504, titled “Overhead Door Monitor and Sensor Apparatus,” filed Jan. 6, 2020, which is incorporated herein by reference in its entirety.

### TECHNICAL FIELD

The present invention relates to an overhead door monitor and sensor apparatus comprising a housing having one or more sensor elements therein attached to an overhead door. The sensor elements collect data from the overhead door, such as whether the door is open or closed, the number of times the overhead door is opened, and operational conditions of the door. Moreover, the information may be stored and may further be wirelessly transferable to a computing device, such as a smart device.

### BACKGROUND

Typical overhead door sensors merely measure an open condition or a closed condition. For example, a common overhead door sensor comprises a magnetic unit attached to the overhead door that interacts with a received unit that is attached to a door frame or floor. When the magnetic unit is adjacent the receiver unit, the door sensor senses that the door is in a closed position. Likewise, when the overhead door opens and the magnetic unit is a distance from the receiver unit, and therefore not detected by the received unit, the door sensor senses that the door is in an open position.

These sensors are limited to only recording when the door is in an open position or a closed position, and cannot detect anything further or different from that. Indeed, it is possible for these types of door sensors to give false readings. If the magnetic unit and/or the receiver unit are misaligned, then the door sensor may not detect that the door is closed or open, providing false readings. Likewise, these sensors cannot detect whether the door is fully open or fully closed, only that the magnetic unit is not sensing the receiver unit. This could happen even if the door is only opened a few inches.

In addition, other data regarding the overhead door cannot be detected and recorded, such as information concerning operational condition of the door, number of counts that the overhead door is in a fully open and fully closed position. A need, therefore, exists for an improved overhead door monitor and sensor apparatus. Specifically, a need exists for an improved overhead door monitor and sensor apparatus that senses and detects one or more operational conditions relating to an overhead door.

More specifically, a need exists for an improved overhead door monitor and sensor apparatus that detects whether an overhead door is in a fully open and a fully closed position. Moreover, a need exists for an improved overhead door monitor and sensor apparatus that senses other data, such as operational conditions of the overhead door. For example, a need exists for an improved overhead door monitor and sensor apparatus that senses vibrations and other operational signatures that determine the operational condition of the door.

In addition, typical sensors do not have means to sense whether a door is impacted by an object. For example, overhead doors are often used on semi-trailers, trucks, delivery vans, or other like vehicles to transport freight that may shift during transport. The freight may impact and damage an overhead door, and the damage may not be overtly detectable by an operator. A need exists for an improved overhead door monitor and sensor that detects impacts to overhead doors. Specifically, a need exists for an improved overhead door monitor and sensor apparatus that may aid in determining whether damage has occurred to an overhead door due to an impact.

Moreover, typical sensors do not store the data sensed and wirelessly communicate the stored data to a receiver for analysis. A need, therefore, exists for an improved overhead door monitor and sensor apparatus that stores operational condition data, such as open and close cycles, impacts, vibrations, and other like operational signatures. Moreover, a need exists for an improved overhead door monitor and sensor apparatus that wirelessly communicates the stored operational condition data to a receiver, such as a computing device, for example, a smart device, so that the operational condition data can be analyzed. Still further, a need exists for an improved overhead door monitor and sensor apparatus that compares operational condition data of an overhead door at one time to operational condition data at a base time to provide information concerning maintenance needs for the overhead door.

### SUMMARY OF THE INVENTION

The present invention relates to an overhead door monitor and sensor apparatus comprising a housing having one or more sensor elements therein attached to an overhead door. The sensor elements collect data from the overhead door, such as whether the door is open or closed, the number of times the overhead door is opened, and operational conditions of the door. Moreover, the information may be stored and may further be wirelessly transferable to a computing device, such as a smart device.

To this end, in an embodiment of the present invention, an overhead door monitor and sensor apparatus comprising: a housing having means configured to attach the housing to a panel of an overhead door; a power source within the housing; a processor connected to the power source; and a first sensor, wherein the first sensor is configured to measure operation condition data of the overhead door.

In an embodiment, the operation condition data comprises an open or a closed position of the overhead door.

In an embodiment, the operation condition data comprises a measure of open and close cycles of the overhead door.

In an embodiment, the first sensor is selected from the group of an accelerometer, a tilt switch, and a gyroscopic sensor.

In an embodiment, the apparatus further comprises: a second sensor.

In an embodiment, the second sensor is selected from the group of a temperature sensor, a humidity sensor, and a photodiode configured to detect changed in light levels.

In an embodiment, the operation condition data comprises a measure of vibrations in the overhead door.

In an embodiment, the operation condition data comprises a measure of vibrations in the overhead door when the overhead door moves from an open position to a close position or from the closed position to the open position.

In an embodiment, the operation condition data comprises baseline data of the operation of the overhead door, and further wherein the operation condition data further comprises operational data of the operation of the overhead door.

In an embodiment, the processor is configured to compare the operational data of the operation of the overhead door to the baseline data of the operation of the overhead door.

In an embodiment, the apparatus further comprises: an alarm condition, such that the comparison of the operational data of the operation of the overhead door to the baseline data of the operation of the overhead door triggers the alarm condition.

In an embodiment, the apparatus further comprises: a wireless transmitter configured to send the operation condition data of the overhead door to a receiver.

In an embodiment, the apparatus of claim 1 further comprises: a storage module configured to store the operation condition data of the overhead door.

In an embodiment, the operation condition data of the overhead door comprises a measure of a number of open and close cycles of the overhead door and vibration information of the overhead door during at least one of the open and close cycles.

In an embodiment, the operation condition data of the overhead door comprises vibrations of the overhead door from an impact of an object against the overhead door.

In an embodiment, the operation condition data comprises baseline data of a measure of vibrations of the overhead door during at least one open and close cycle of the overhead door.

In an embodiment, the operation condition data comprises operational data of a measure of vibrations of the overhead door during at least another open and close cycle of the overhead door.

In an embodiment, the processor compares the operational data to the baseline data to form comparison data.

In an embodiment, the comparison data is submitted to a receiver via a wireless transmitter.

In an alternate embodiment of the present invention, a system is provided. The system comprises: the overhead door monitor and sensor apparatus; and an overhead door, wherein the overhead door is disposed on a semi-trailer, a truck, a van, a garage, or a shipping container.

It is, therefore, an advantage and objective of the present invention to provide an improved overhead door monitor and sensor apparatus.

Specifically, it is an advantage and objective of the present invention to provide an improved overhead door monitor and sensor apparatus that senses and detects one or more data relating to a condition of an overhead door.

More specifically, it is an advantage and objective of the present invention to provide an improved overhead door monitor and sensor apparatus that detects whether an overhead door is in a fully open and a fully closed position.

Moreover, it is an advantage and objective of the present invention to provide an improved overhead door monitor and sensor apparatus that senses other operational conditions of the overhead door.

For example, it is an advantage and objective of the present invention to provide an improved overhead door monitor and sensor apparatus that senses vibrations and other operational signatures that determine the operational condition of the door.

Further, it is an advantage and objective of the present invention to provide an improved overhead door monitor and sensor that detects impacts to overhead doors.

Specifically, it is an advantage and objective of the present invention to provide an improved overhead door monitor and sensor apparatus that may aid in determining whether damage has occurred to an overhead door due to an impact.

Still further, it is an advantage and objective of the present invention to provide an improved overhead door monitor and sensor apparatus that stores operational condition data, such as open and close cycles, impacts, vibrations, and other like operational signatures.

Moreover, it is an advantage and objective of the present invention to provide an improved overhead door monitor and sensor apparatus that wirelessly communicates the stored operational condition data to a receiver, such as a computing device, for example, a smart device, so that the operational condition data can be analyzed.

In addition, it is an advantage and objective of the present invention to provide an improved overhead door monitor and sensor apparatus that compares operational condition data of an overhead door at one time to operational condition data at a base time to provide information concerning maintenance needs for the overhead door.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an overhead door monitor and sensor apparatus in an embodiment of the present invention.

FIG. 2 illustrates an electrical schematic of an overhead door monitor and sensor apparatus in an embodiment of the present invention.

FIG. 3 illustrates an overhead door monitor and sensor apparatus attached to an overhead door in a closed position in an embodiment of the present invention.

FIG. 4 illustrates an overhead door monitor and sensor apparatus attached to an overhead door in an open position in an embodiment of the present invention.

### DETAILED DESCRIPTION OF THE PRESENTLY PREFERRED EMBODIMENTS

The present invention relates to an overhead door monitor and sensor apparatus comprising a housing having one or more sensor elements therein attached to an overhead door. The sensor elements collect data from the overhead door, such as whether the door is open or closed, the number of times the overhead door is opened, and operational conditions of the door. Moreover, the information may be stored and may further be wirelessly transferable to a computing device, such as a smart device.

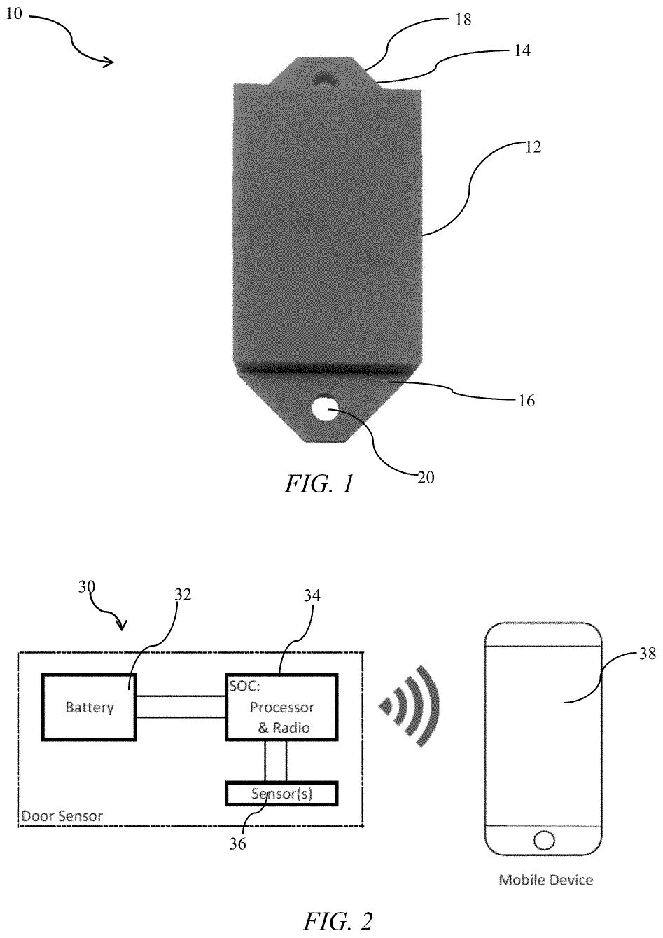

Referring now to FIG. 1, an overhead door monitor and sensor apparatus 10 is illustrated. The overhead door monitor and sensor apparatus 10 comprises a housing 12 having first flat extension 14 and second flat extension 16 extending from opposite ends thereof, each of the first and second flat extensions 14, 16 having apertures 18, 20, respectively, disposed therein for receiving a screw for attaching the overhead door monitor and sensor apparatus 10 to an overhead door. Alternatively, the apparatus 10 may be attached to the overhead door via adhesive, hook-and-loop fasteners, or any other manner to ensure that the apparatus is rigidly disposed on the overhead door.

The housing 12 of the overhead door monitor and sensor apparatus 10 may be relatively compact, preferably measuring approximately 1 inch wide by 2 inches long, by ½ inch thick, although the apparatus 10 may be any size and shape and should not be limited as described herein. The housing 12 may further preferably be made from waterproof or water-resistant plastic, although the housing 12 may be made from any material.

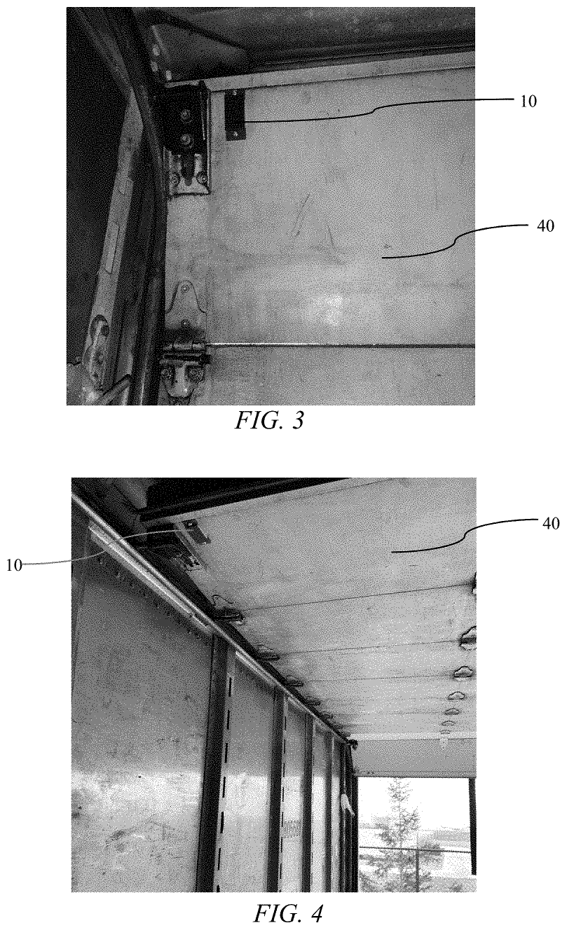

As illustrated in FIGS. 3 and 4, the overhead door monitor and sensor apparatus 10 may be attached to an overhead door 40 that may have a closed position (as illustrated in FIG. 3) and an open position (as illustrated in FIG. 4). The overhead door 40 may be utilized on a semi-trailer, truck, van, a garage, a shipping container, or any other like overhead door that typically follows a track and is generally driven by a spring or springs, although the apparatus 10 may be utilized on motorized doors, such as overhead doors driven by a motorized operator.

FIG. 2 illustrates a simple electrical schematic 30 of the overhead door monitor and sensor apparatus 10 in an embodiment of the present invention. In a preferred embodiment, the overhead door monitor and sensor apparatus 10 may comprise a battery 32, an SOC 34 (also known as a “system on a chip”) and one or more sensors 36 including, but not limited to, an accelerometer, a tilt switch, a gyroscopic sensor, and other like sensors for measuring movement, position and/or vibrations of the overhead door. The overhead door monitor and sensor apparatus 10 may further have an operating switch or sensor for activating the sensor when in use, such as a reed switch, an external button, or the like. Preferably, the apparatus 10 may generally be in a “sleep” mode, thereby preserving battery power and may further be activated when one or more sensors detect movement thereof, such as via an accelerometer or the like. Moreover, the overhead door monitor and sensor apparatus 10 may have other sensors, such as a temperature sensor, a humidity sensor, a photodiode for detecting changes in light levels, and other like sensors for detecting or sensing various conditions.

The SOC 34 may comprise various elements that drive functionality thereon, specifically, a processor and a RF transmitter or transceiver for communicating with a computing device via a communication protocol, such as Bluetooth, Wi-Fi, or other like communication means. Preferably, the overhead door monitor and sensor apparatus 10 may communicate via an RF communication protocol with a smart device 38, as illustrated in FIG. 2. The user may utilize the smart device to communicate with the overhead door monitor and sensor apparatus 10 to obtain data collectible thereby. Alternatively or in addition thereto, the apparatus 10 may communicate with a smart home device hub, vehicle device hub, a gate and/or yard hub/reader via wired or wireless communication. For example, the apparatus 10 may communicate with a device that is disposed within a parking area or garage that may wirelessly monitor for apparatuses 10 of the present invention for communication therewith. Operation condition data, detected by the apparatus herein, may thus be sent from a transmitter within the apparatus 10 to a receiver, as described above. The data may be sent at regular intervals to the receiver, when requested by a receiver thereof (requiring that the apparatus 10 further comprise a receiver of the request), or when an alarm condition is triggered by the data within the processor.

In a preferred embodiment of the present invention, the overhead door monitor and sensor apparatus 10 may utilize the accelerometer, tilt switch, gyroscopic sensor, light sensor or other like sensor, to detect the movement of the overhead door 40 to which the apparatus 10 is attached. Preferably, the apparatus 10 includes a single or tri-axis accelerometer. Specifically, the apparatus 10 may utilize the accelerometer to detect overhead door movement, based on vibrations of the same when in motion, or may detect a change in orientation of the apparatus 10, such as when the overhead door and, thus, the apparatus 10 moves between a vertical position (indicating that the overhead door is in the closed position) and a horizontal position (indicating that the overhead door is in the open position). When attached to a panel of the overhead door, preferably an inside or outside top panel thereof, the movement and/or orientation of the overhead door may be easily detectable.

Preferably, the sensor may be activated by a user at the time of installation using a software application, such as an application resident on a computing device, such as a smart device, in RF communication with the apparatus 10 and a button, motion sensor, or other trigger mechanism on the apparatus 10. Once activated, the apparatus 10 may cycle the door at least once fully opened and then closed so that the sensor may learn, sense and detect a baseline operation of the door. The accelerometer, tilt sensor, gyroscopic sensor, or other like sensor may detect orientation data, vibration data, humidity data, temperature, data, and/or other like data, which may then be stored within a storage module within the apparatus 10 and/or communicated to the smart device. Once baseline information is collected, the apparatus 10 may then begin collecting operational data on the overhead door 40.

Preferably, within the apparatus 10, as noted above, the accelerometer may monitor the status of the overhead door 30. As the door opens, requiring the overhead door 40 to tilt back, as illustrated in FIG. 4, and transition from a vertical track through a track radius, to a horizontal section, the accelerometer may register the change in orientation. The processor on the SOC 34 monitoring the overhead door 40 may increment the door count one time. Thus, a total number of door cycles may be detected and stored. This information may be presented to a user thereby providing a user with data concerning when maintenance and/or replacement thereof may be necessary. Preferably, substantial filtering may be done to ensure that false readings of door opening and closing are not detected.

In an alternate embodiment of the present invention, the apparatus 10 may sense and record other data that may be useful for an owner to determine when maintenance and/or replacement thereof may be necessary. For example, the accelerometer or other like sensor may detect vibration information that may be compared to baseline information and that may further be utilized to alert a user that maintenance is required. Specifically, detected vibrations may be present that were not present earlier or not present at the relative amount as first detected in a baseline vibration measurement. The detected vibrations may indicate that the overhead door is operating poorly and needs maintenance or replacement. Different overhead door issues may generate signature vibrations that may be detected by the apparatus 10. Based on the signature vibrations, overhead door operational diagnostics may be performed that may provide information on the precise issues with the overhead door that may be need maintenance.

In another embodiment of the present invention, the apparatus 10 may be utilized to detect when potentially damaging impacts occur to the overhead door. For example, when an overhead door is closed and in a vertical orientation, freight or other like objects may strike the overhead door when in transit. The apparatus 10, specifically, one or more of the various sensors therein, may detect these events and record the same. When a user communicates with the apparatus 10 via his or her smart device, he may be informed that an event of this nature has occurred, which may lead the user to inspect the overhead door for damage. Preferably, in a particularly preferred embodiment, the accelerometer may be a tri-axial accelerometer, whereby one of the sensor axes may be utilized to detect impact events against the overhead door.

A user may utilize a software application resident on a smart device, such as a computer, smart phone, tablet, or other like device, to communicate with the apparatus 10 via wired or, preferably, wireless transmission of data. The software application may allow a user to connect to the apparatus 10 and receive from and/or transmit information to the apparatus 10. Information received from the apparatus 10 by the smart device may be displayed so that a user may easily determine specific information detected. For example, a user may determine the number of open/close cycles the overhead door 40 has performed in its lifetime or in a discrete defined period of time. The software application may inform a user that routine inspection and/or maintenance may be required on the overhead door 40 based on the number of open/close cycles performed. Other like information may be gleaned by a user, such as, for example, average open/close cycles per day or over any other time interval, battery life left, or other like information. As noted above, the user may also transmit information to the apparatus 10, such as a custom ID for security purposes or for resetting an interval counter.

The software application may further provide information to the user concerning possible impacts to the overhead door 40 that may be caused by, for example, shifting freight. As noted above, one or more sensors within the apparatus 10 may detect impacts to the overhead door 40, such as by detecting vibrations to the overhead door 40 indicating that an impact has occurred.

Moreover, the software application may store and process information detected by the sensors, such as information concerning a baseline reading of vibrations to the overhead door 40, such as when the overhead door 40 is installed or at the start of a measuring interval, and may compare vibrations detected at other time periods to determine operational condition of the overhead door 40 when opening or closing. The software application may compare the vibrations detected for the overhead door 40 during an open/close cycle, and compare those vibrations to the baseline vibrations detected at the start of a measuring period. Relative changes in vibrations as the overhead door 40 travels along the track in either the open or close direction may be utilized to determine whether inspection and/or maintenance may be required on the overhead door 40.

Moreover, the software application may be programmed to automatically send data to a centralized location when connected via wireless communication. For example, when the apparatus 10 is connected to a wireless network, the apparatus 10 may send a data packet to a centralized location, which may then subsequently be received by a user even when the apparatus 10 is not connected anymore. The automatic connection may be made to a smart device, such as a computer, smart phone, tablet or gateway hub, which may be located in a vehicle yard, maintenance garage, or other similar locations.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1. An overhead door monitor and sensor apparatus comprising:
a housing having means configured to attach the housing to a panel of an overhead door;
a power source within the housing;
a processor connected to the power source; and
a first sensor,
wherein the first sensor is configured to measure operation condition data of the overhead door.

2. The apparatus of claim 1 wherein the operation condition data comprises an open or a closed position of the overhead door.

3. The apparatus of claim 1 wherein the operation condition data comprises a measure of open and close cycles of the overhead door.

4. The apparatus of claim 1 wherein the first sensor is selected from the group of an accelerometer, a tilt switch, and a gyroscopic sensor.

5. The apparatus of claim 1 further comprising:
a second sensor.

6. The apparatus of claim 4 wherein the second sensor is selected from the group of a temperature sensor, a humidity sensor, and a photodiode configured to detect changed in light levels.

7. The apparatus of claim 1 wherein the operation condition data comprises a measure of vibrations in the overhead door.

8. The apparatus of claim 1 wherein the operation condition data comprises a measure of vibrations in the overhead door when the overhead door moves from an open position to a close position or from the closed position to the open position.

9. The apparatus of claim 1 wherein the operation condition data comprises baseline data of the operation of the overhead door, and further wherein the operation condition data further comprises operational data of the operation of the overhead door.

10. The apparatus of claim 8 wherein the processor is configured to compare the operational data of the operation of the overhead door to the baseline data of the operation of the overhead door.

11. The apparatus of claim 9 further comprising:
an alarm condition, such that the comparison of the operational data of the operation of the overhead door to the baseline data of the operation of the overhead door triggers the alarm condition.

12. The apparatus of claim 1 further comprising:
a wireless transmitter configured to send the operation condition data of the overhead door to a receiver.

13. The apparatus of claim 1 further comprising:
a storage module configured to store the operation condition data of the overhead door.

14. The apparatus of claim 1 wherein the operation condition data of the overhead door comprises a measure of a number of open and close cycles of the overhead door and vibration information of the overhead door during at least one of the open and close cycles.

15. The apparatus of claim 1 wherein the operation condition data of the overhead door comprises vibrations of the overhead door from an impact of an object against the overhead door.

16. The apparatus of claim 1 wherein the operation condition data comprises baseline data of a measure of vibrations of the overhead door during at least one open and close cycle of the overhead door.

17. The apparatus of claim 16 wherein the operation condition data comprises operational data of a measure of vibrations of the overhead door during at least another open and close cycle of the overhead door.

18. The apparatus of claim 17 wherein the processor compares the operational data to the baseline data to form comparison data.

19. The apparatus of claim 18 wherein the comparison data is submitted to a receiver via a wireless transmitter.

20. A system comprising:
the overhead door monitor and sensor apparatus of claim 1; and
an overhead door, wherein the overhead door is disposed on a semi-trailer, a truck, a van, a garage, a warehouse, or a shipping container.
